(19) United States
(12) Patent Application Publication
(10) Pub. No.: US 2010/0014627 A1
(43) Pub. Date: Jan. 21, 2010

(54) METHOD AND APPARATUS FOR CT IMAGE COMPRESSION

(76) Inventor: Yuanji Wang, Beijing (CN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/502,867

(22) Filed: Jul. 14, 2009

(30) Foreign Application Priority Data
Jul. 18, 2008 (CN) 200810137772.4

(51) Int. Cl. H05G 1/60; G06K 9/00

(52) U.S. Cl. 378/4; 382/131; 382/232

(57) ABSTRACT

A method for compressing a CT-reconstructed image includes obtaining a reconstructed image to be compressed, wherein the reconstructed image includes an area within field of view and an area outside field of view. The method also includes determining, according to the preset CT value classification templates, which type of CT value classification template the CT value of each of the pixels in the area within field of view in the image belongs to, and compressing the pixel data that belong to the respective CT value classification templates according to the CT value classification templates and compression methods determined for the respective classification templates.

### FIELD OF THE INVENTION

The embodiments described herein relate to image compression techniques, and in particular to Computerized Tomography (CT) image compression.

### CROSS REFERENCE TO RELATED APPLICATIONS

This application claims the benefit of Chinese Patent Application No. 200810137772.4 filed Jul. 18, 2008, which is hereby incorporated by reference in its entirety.

### BACKGROUND OF THE INVENTION

In a CT system, an image storage capacity is a very important parameter of system performance. In order to increase the image storage capacity, the existing method is adding hard discs, which increases the cost, too. Thus a method appears which increases the image storage capacity of the CT system by compressing the image of Digital Imaging and Communications in Medicine (DICOM). There are two typical image compression methods: lossless compression and lossy compression. The lossless compression comprises compression methods like Huffman encoding, algorithm encoding, etc., which has a comparatively low compression ratio. The lossy compression comprises compression methods like DCT (Discrete Cosine) encoding, Predictive encoding, vector quantization, etc., which has a comparatively high compression ratio. The compression method disclosed in the prior art, such as in the application CN20610089179 of Siemens, needs to use the data of the neighboring images when encoding an image, so if the neighboring images are not highly relevant to said image to be encoded, the effect of encoding would be bad.

### BRIEF DESCRIPTION OF THE INVENTION

Aspects of the invention provide a method and apparatus for CT image compression, which compress the amount of information required to store the CT image, thereby increasing the image storage capacity of a CT system.

One aspect provides a method for compressing a CT-reconstructed image, which includes obtaining the reconstructed image to be compressed, wherein the reconstructed image includes an area outside field of view and an area within field of view. The method also includes determining, according to the preset CT value classification templates, which type of CT value classification template the CT value of each of the pixels in the area within field of view in the image belongs to and compressing the pixel data that belong to the respective CT value classification templates according to said CT value classification templates and compression methods determined for the respective classification templates.

In another aspect, the method for compressing a CT-reconstructed image further comprises the steps of removing data in the area outside field of view and establishing the corresponding record information.

The reconstructed image is an image in Digital Imaging and Communications in Medicine (DICOM) format, which is a matrix of 512×512.

The preset CT value classification templates include the four types of A[−1024˜−111], B[−110˜145], C[146˜657], D[658˜3071]. Image data in the CT value classification template B[31 110˜145] are compressed in a lossless manner, and image data in the CT value classification templates A[−1024˜−111], C[146˜657] and D[658˜3071] are compressed in a lossy manner.

The compression corresponding to said A, B, C and D types of CT value classification templates is performed according to the formula of

$$y = \frac{x - intercept}{slope} ,$$

wherein y is the result of compression, x is the CT value of the respective pixels, intercept is the lower limit value of each classification template; slope is the compression ratio of each classification template, which is a constant and can be defined by a user according to his own requirement; wherein, the compression ratio slope corresponding to the CT value classification template B[−110˜145] is 1; and the compression ratios slopes corresponding to the CT value classification templates A[−1024˜−111], C[146˜657] and D[658˜3071] are 4, 2 and 9 respectively.

The A, B, C and D types of CT value classification templates are represented by binary numbers. Specifically, A is represented by 00, B is represented by 01, C is represented by 10 and D is represented by 11.

The CT value of the pixels in the area outside field of view is −3024.

Another aspect provides a method for decompressing said compressed CT-reconstructed image, which includes obtaining the image data to be decompressed, decompressing the compressed image data using the corresponding decompression algorithm according to the CT value classification template where each of the pixel data resides, recovering the image data in the area outside field of view, and adding the data in the area outside field of view to the decompressed image to obtain a complete image

Wherein, the compressed image data are decompressed using the formula of x-y·slope+intercept, wherein x represents the decompressed image data, y represents the compressed image data, and the compression ratio slope and the intercept depend on the CT value classification templates where they reside in.

Yet another aspect provides a CT apparatus, which comprises: a scanning table performing X-ray scanning on a subject; a data collection unit for collecting the scanning data output from the scanning table and performing an analog-to-digital conversion thereon; an image reconstruction unit for reconstructing an image according to the scanning data sent from the data collection unit, and storing the reconstructed image data in a storage unit and/or displaying the reconstructed image data on a user operation interface through a central control unit; the user operation interface for enabling the user's operation; the storage unit for storing data and information; and the central control unit connected to the output terminal of said image reconstruction unit and controlling the scanning table, the data collection unit, the user operation interface and the storage unit; the storage unit stores the CT value classification templates and the compression and decompression algorithms applied to the CT value classification templates; the CT apparatus further comprises an image compression/decompression computing unit, which, under the control of the central control unit, calls the CT value classification templates and the corresponding compression and decompression algorithms stored in the storage unit to compress the reconstructed image or to decompress the compressed image.

The image compression/decompression computing unit comprises a compression computing unit and a decompression computing unit; the central control unit can automatically control the compression computing unit in the image compression/decompression computing unit to compress the image reconstructed by the image reconstruction unit, or the corresponding compression instruction can be sent to the central control unit by the user operating on the user operation interface.

The image reconstructed by the reconstruction unit is an image in DICOM format, which is a matrix of 512×512 and comprises an area within field of view and an area outside field of view.

The CT value classification templates include four types of A[−1024˜−111], B[−110˜145], C[146˜657], D[658˜3071]. Image data in the CE value classification template B[−110˜145] are compressed in a lossless manner, and image data in the CT value classification templates A[−1024˜−111], C[146˜657] and D[658˜3071] are compressed in a lossy manner.

The compression corresponding to said A, B, C and D types of CT value classification templates is performed according to the formula of

$$y = \frac{x - intercept}{slope} ,$$

wherein y is the result of compression, x is the CT value of the respective pixels, intercept is the lower limit value of each classification template; slope is the compression ratio of each classification template, which is a constant and can be defined by a user according to his own requirement; wherein, the slope corresponding to the CT value classification template B[−110˜145] is 1; the corresponding method of decompressing the compressed image data is x=y·slope+intercept, wherein x represents the decompressed image data, y represents the compressed image data, the compression ratio slope and the intercept depend on the respective CT value classification templates where they reside in; and y·slope represents the product of y and slope.

The slopes corresponding to the CT value classification templates A[−1024˜−111], C[146˜657] and D[658˜3071] are 4, 2 and 9 respectively.

The A, B, C and D types of CT value classification templates are represented by binary numbers. Specifically, A is represented by 00, B is represented by 01, C is represented by 10 and D is represented by 11.

When the compression computing unit receives the instruction of compressing the reconstructed image sent from the central control unit, it calls the reconstructed image data to be compressed from the storage unit and deletes the data in the area outside field of view in the image, and determines which CT value classification template the CT value of each of the pixels in the area within field of view in the image belongs to, and then compresses the pixel data according to the compression algorithm of the CT value classification templates to which the respective pixels belong; an operation key of “Delete Air Data” is provided on the user operation interface.

When the decompression computing unit receives the instruction of decompressing the compressed reconstructed image sent from the central control unit, it calls the image data to be decompressed from the storage unit and decompresses the compressed pixel data according to the decompression algorithm of the CT value classification templates to which the respective pixels belong, and recovers the image data in the area outside field of view, and then adds the data in the area outside field of view to the decompressed image to obtain a complete image.

When the compression computing unit deletes data in the area outside field of view, it creates and stores a piece of corresponding record information in the storage unit at the same time; the image data compressed by the compression computing unit or the image data decompressed by the decompression computing unit are stored in the storage unit.

By means of the CT value classification according to the present invention, the user can perform lossless compression on the important image data according to his own needs, while the image data that are not of great significance to clinical diagnosis can be compressed with losses in different degrees, so that there is no loss in the data of the important tissue information. As for the data that are partially lost, including data of the air and the bones, they will not greatly influence the diagnosis. The present invention compresses different CT value pixel data in different ways according to the CT value classification templates, so that it not only effectively ensures the validity of the compressed data, but also greatly increases the compression ratio, enhances the image storage capability of the CT system, and improves the image transfer capability. Meanwhile, the compression method of the present invention can be used jointly with other methods to achieve higher compression ratio, so it has good compatibility.

### BRIEF DESCRIPTION OF THE DRAWINGS

FIG. 1 is a flow chart of a method of compressing image data;

FIG. 2 is a schematic drawing of a DICOM image obtained after reconstruction by the CT apparatus;

FIG. 3a is a schematic drawing of the ranges of CT values of human tissues;

FIG. 3b shows an embodiment of the CT value classification templates where each of the pixels of the DICOM image in FIG. 2 reside in;

FIG. 4a is a schematic drawing of compressing the pixel data in the classification template C;

FIG. 4b is a schematic drawing of compressing the pixel data in the A, B and D classification templates respectively;

FIG. 5 is a flow chart of a method of decompressing the image data that are compressed by the compression method as shown in FIG. 1;

FIG. 6 is a schematic drawing of the DICOM image that is operated by a user; and

FIG. 7 is a schematic drawing of functional modules of the CT apparatus having the function of compressing a CT reconstructed image.

### DETAILED DESCRIPTION OF THE INVENTION

Embodiments of the invention are described in detail below with reference to the figures, but the invention is not limited to these embodiments.

The CT image compression method of the present invention performs a lossy or lossless compression on a DICOM image based on the CT values of the subject tissue in the image, such as the CT values of human organs and tissues, such that it ensures that not only the important image data will not be lost, but also the image storage capacity of the CT system is greatly increased.

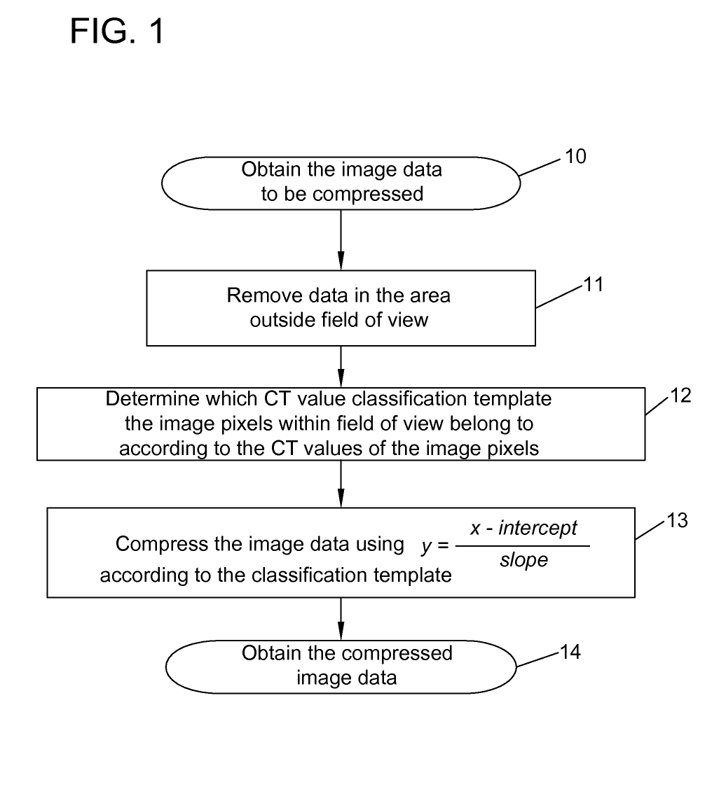

A CT image compression method of the present invention is illustrated with reference to FIG. 1 that shows a flow chart of the compression method of the present invention, take a human body for example:

Step 10) obtaining the DICOM image data to be compressed.

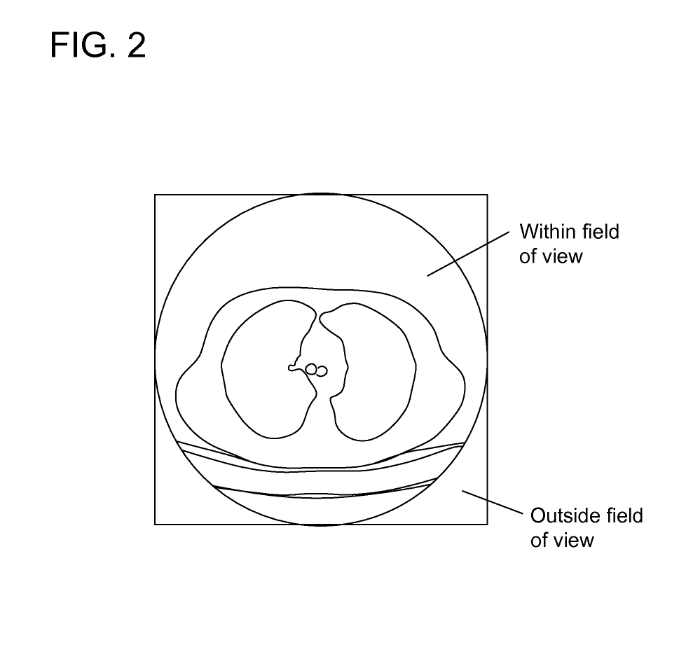

See FIG. 2 at the same time, which is a CT DICOM image. The DICOM image data generally comprises two parts of contents, i.e. head information and image data. The head information records patient's information, scanning protocol, etc. The general CT image data include 512×512 pixels, and each pixel is represented by two bytes (16 bits). FIG. 2 shows a typical 512×512 CT DICOM image with a size of 527672 bytes, including the head information of 3384 bytes and the image data of 524288 bytes. The compression of the present invention is only for the image data.

Step 11) removing data in an area outside field of view.

It can be seen from FIG. 2 that the DICOM image data is a matrix of 512×512 which includes two parts, i.e. a part outside field of view and a part within field of view. The data within field of view are the real image data, which are the inscribed circle of the image matrix. The data outside field of view is useless to the doctor's clinical diagnosis. Usually, the data outside field of view are set to special CT values, e.g. −3024, as shown by the black part in FIG. 2, so that the image within field of view can be notably distinguished from the image. Since the part outside field of view is not the real image data, data of said part can be deleted to reduce the size of the DICOM image. Such deletion of the data of the part outside field of view can reduce the image data by 21.5% (i.e. 1−π/4). Meanwhile, a mark is created for the deleted information, for example, the head information contains the information of “data in the area outside field of view with the CT value of −3024”.

Step 12) determining, according to the preset CT value classification templates, which CT value classification template the CT value of each of the pixels of the image within field of view belongs to.

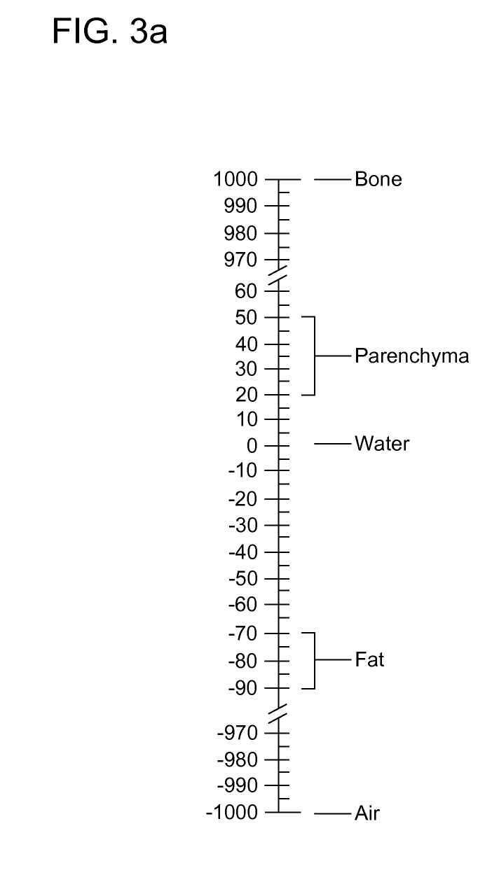

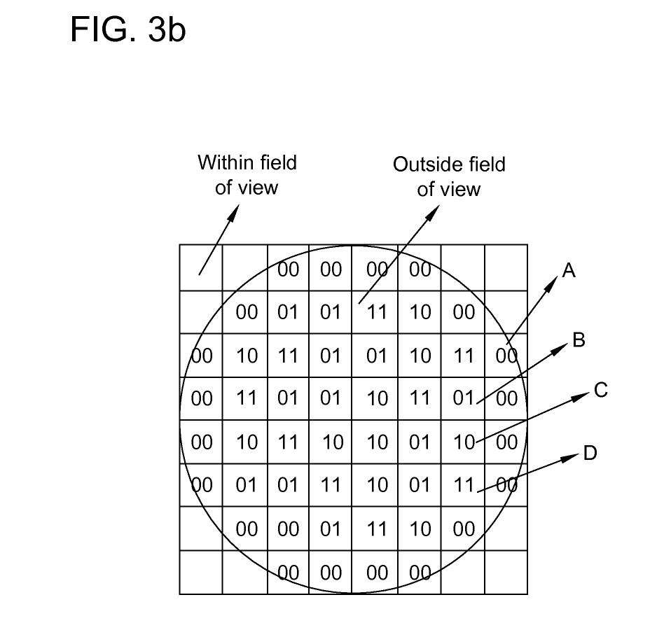

For a general CT image, the range of CT values is from −1024 to 3071 (4096 in total), and the CT value of each pixel is stored in the manner of 2 bytes, i.e. 16 bits. The CT values of typical human tissues are shown in Table 1 and FIG. 3a. FIG. 3a shows the ranges of CT values of human tissues.

TABLE 1

| Tissues | Ranges of CT values |
|---|---|
| Blood plasma | 3~14 |
| Blood | 13~32 |
| Calcium | 60~300 |
| Thyroid gland | 50~80 |
| Liver | 45~75 |
| Spleen | 35~55 |
| Muscle | 35~50 |
| Pancreas | 25~55 |
| Cerebral cortex | 32~40 |
| Cerebral medulla | 28~32 |
| Fat | −50~−100 |
| Bone | 400~1000 |
| Air | −1010~−990 |

In order to compress image data, the ranges of CT values can be classified as four types: A[−1024˜−111], B[−110˜145], C[146˜657] and D[658˜3071]. It can be seen from Table 1 and the classification on of CT values that the most important range of CT values is the B[−110˜145] template, which covers most of the tissues of a human body. For this part, even a very small error may influence the result of clinical diagnosis, so a lossless compression is performed on this part in the present invention. For the C[146˜657] template, it includes calcium and bone, so an error of one CT value is acceptable. For the A[−1024˜−111] template, it mainly includes air, so an error of two CT values is acceptable. For the D[658˜3017] template, it mainly includes bone and metal, so an error of four CT values is acceptable. This way of classification ensures that the B type template is compressed in a lossless manner, while for the compression of the C type template, the maximum error is one CT value, and for the A type template and D type template, the maximum errors are 2 CT values and 4 CT values, respectively.

Embodiments described herein use the following method to mark which classification template each of the pixel data belongs to. Since there are altogether four types, they can be differentiated by binary numbers. For example, A is represented by 00, B is represented by 01, C is represented by 10 and D is represented by 11. As shown in FIG. 3b, all the pixel data falling within the range A are represented by 00, all the pixel data falling within the range B are represented by 01, all the pixel data falling within the range C are represented by 10, and all the pixel data falling within the range D are represented by 11.

Step 13) compressing the pixel data that belong to the respective CT value classification templates according to said classification templates and compression methods determined for the respective classification templates.

This embodiment uses the following formula (1) to compress the pixel data in an image:

$$y = \frac{x - intercept}{slope} , \qquad ( 1 )$$

wherein y is the result of compression, x is the CT value of the respective pixels, intercept represents an intercept, i.e. the lower limit value of each classification template; slope represents a slope, i.e. the compression ratio of each classification template, which is a constant and can be defined by a user according to his own requirement.

Each classification template corresponds to a different intercept and a compression ratio slope. The intercept depends on the lower limit value of said classification template. For example, the intercept of B classification template is −110, and the intercept of C classification template is 146. The compression ratio slope can be set by a user according to his own required compression ratio, but the slope should be an integer greater than or equal to 1.

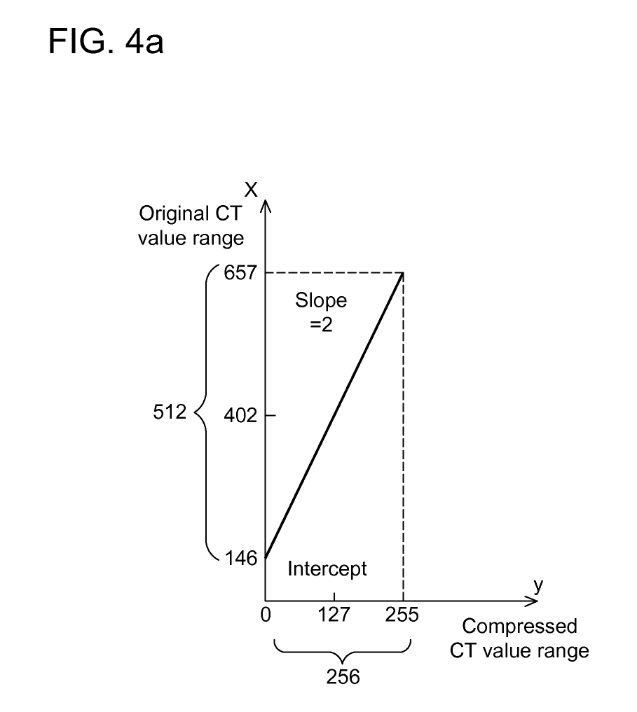

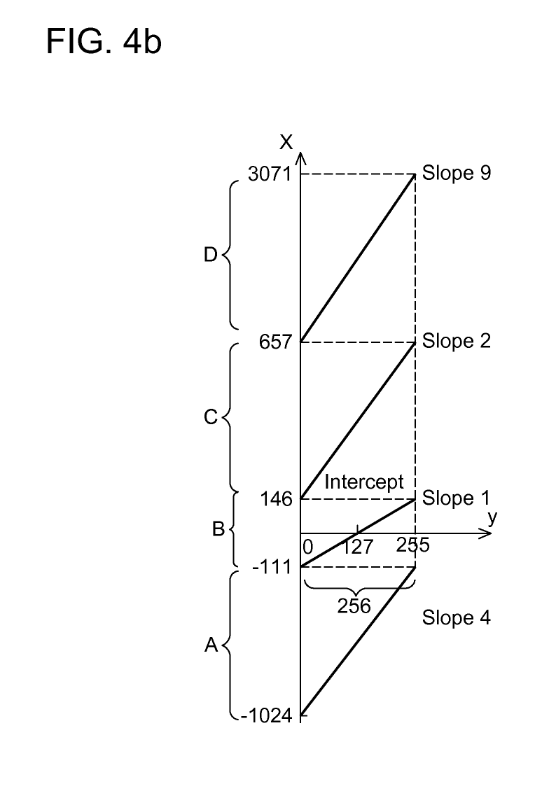

Compression of the C classification part is illustrated below as an example. As shown in FIG. 4a, the compression is a linear compression, and the result of compression satisfies the above formula (1). The range of values of the pixels herein is compressed from the original [146˜675] to [0˜255], the range of original CT value x is [146˜675], the intercept is 146, the compression ratio is 2, and the compression error is slope/2, i.e. 1 CT value. The range of the compression result y is [0˜255], which just satisfies compression from a binary length of 16 bits to a length of 8 bits. Thus the parameters of intercept and slope of formula (1) applied to the C classification template are established to be 146 and 2, respectively.

Referring to FIG. 4b at the same time, the other classification parts are compressed by means of the same compression method, and the parameters of intercept and slope of formula (1) applied to the A, B and D classification templates are obtained. For classification template A[−1024˜−111], the intercept is −1024, and the slope is 4; for classification template B[−110˜145], the intercept is −110, and the slope is 1; and for classification template D[658˜3071], the intercept is 658 and the slope is 9.

Step 14) obtaining the compressed image data.

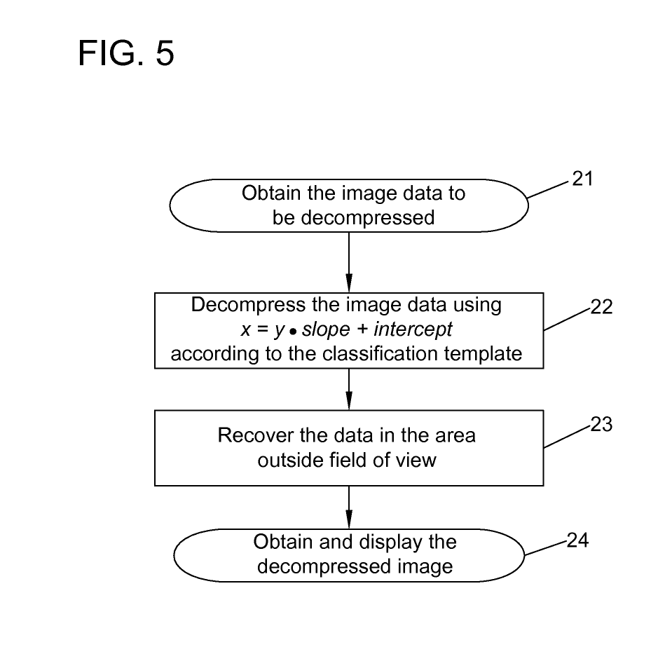

In order to recover the image before being compressed, the compressed image data should be decoded. See FIG. 5, which shows a flow chart of a method of decompressing the compressed image, which includes:

21) obtaining the image data to be decompressed;

22) decompressing the compressed image data using the corresponding decompression algorithm according to the CT value classification template where each of the pixel data resides in.

This embodiment uses the following formula (2) to decompress the compressed image data:

x=y·slope+intercept (2), wherein x represents the decompressed image data, y represents the compressed image data obtained by the above-mentioned compression method, as in the compression, the compression ratio slope and intercept here depend on the respective CT value classification templates where they reside in; and y·slope represents the product of y and slope.

Step 23) recovering the data of the area outside field of view according to the recording in the head information.

Step 24) adding the data of the area outside field of view to the decompressed image to obtain a complete image.

The method of compressing the CT DICOM image in this embodiment has a compression ratio of

$$\frac{π}{4} \times \frac{10}{16} = 0.49 ,$$

which is close to 2:1 and is a higher compression ratio which can greatly increase the image storage capacity of the CT system. Wherein,

$$\frac{π}{4}$$

is obtained by deleting data in the area outside field of view, and

$$\frac{10}{16}$$

is obtained by compressing the image data from 16 bits to 10 bits (image data of 8 bits and classification template data of 2 bits). The use of the CT value classification templates ensures that important tissue information, such as the part in the B classification template, will not be damaged and lost. For the lost parts such as air and bone, they do not have too much influence on the clinical diagnosis. In addition, the degree of loss is acceptable. The compression method of the present invention does not affect the use of other compression methods, so other lossy and lossless compression methods can also be used to compress said CT DICOM image to thereby increase the compression ratio of the image.

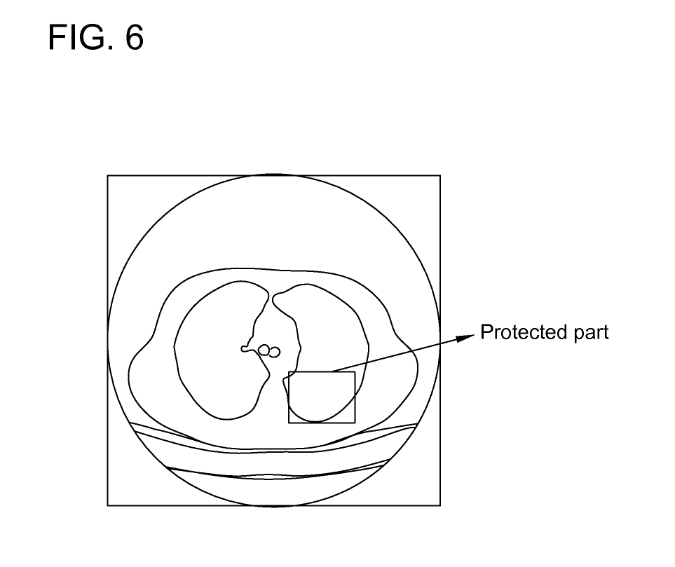

In the compression methods described herein, a user may choose not to perform the compression according to his own requirement, for example, if the user does not want to compress a lesion or pathologically changed area, he may select said area to protect it, as shown in FIG. 6.

In the compression methods described herein, many existing compression techniques can be used based on the CT value classification templates. For example, with respect to the B classification part, since data of said part are very important, image data in said part are compressed by lossless encoding (e.g. Huffman encoding), while as for the A, C and D classification parts, since data thereof are not of great significance to clinical diagnosis, they may be compressed by lossy encoding (e.g. DCT encoding) to increase the compression ratio. Of course, in order to obtain the valid decompressed image data, the decoding algorithm for decompression should be corresponding to the encoding algorithm for compression.

Generally, a CT image includes a lot of air data. They are substantially useless to clinical diagnosis in images other than the lung image, so in order to increase the compression ratio, image data of this part may be removed as what is done to the data in the area outside field of view. Of course, there should be information that records the deleted air information, for example, the head information contains “air data with the CT value of −1000” so as to recover the image data.

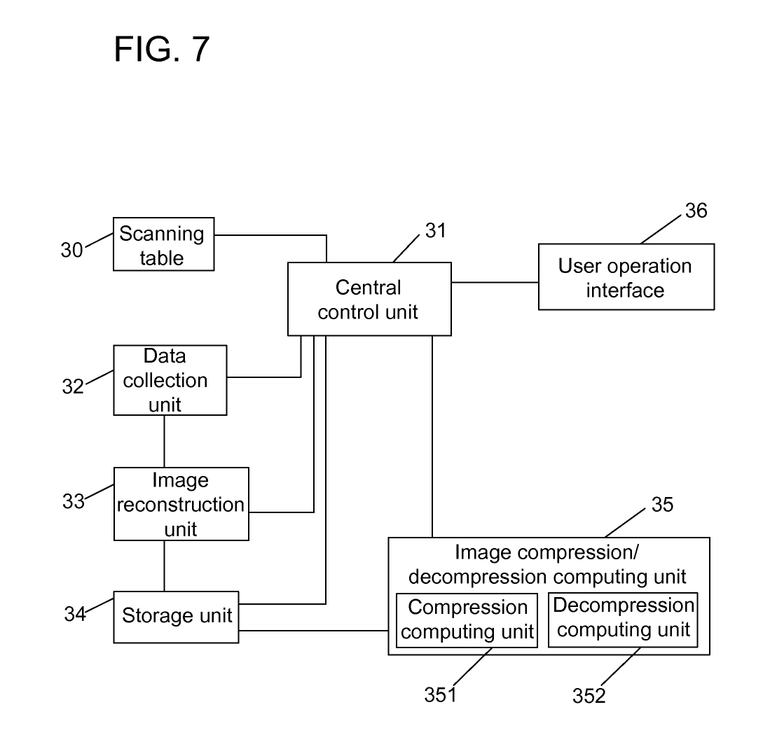

The CT apparatus for compressing the CT DICOM image using the compression method of the present invention, as shown in FIG. 7, comprises a scanning table 30 which performs X-ray scanning on a subject, including horizontal scanning, axial scanning, helical scanning or scanning of a certain position; a data collection unit 32 which collects the scanning data output by the scanning table 30, including the scanning data obtained by horizontal scanning, axial scanning, helical scanning or scanning of a certain position, and performs an analog-to-digital conversion on the data; an image reconstruction unit 33 which performs image reconstruction based on the scanning data sent from the data collection unit, stores the image data obtained by reconstruction in a storage unit 34, and displays the data on a user operation interface 36 through a central control unit 31; a user operation interface 36 for a user to operate; and a central control unit 31 which is connected to the output terminal of the image reconstruction unit 33 and which controls the scanning table 30, the data collection unit 32, the user operation interface 36 and the storage unit 34. Said CT apparatus further comprises an image compression/decompression computing unit 35, which, under the control of the central control unit 31, compresses the DICOM image reconstructed by the image reconstruction unit 33 or decompresses the compressed DICOM image.

The image compression/decompression computing unit 35 comprises a compression computing unit 351 and a decompression computing unit 352. The central control unit 31 can automatically control the compression computing unit 351 in the image compression/decompression computing unit 35 to compress the DICOM image reconstructed by the image reconstruction unit 33, or the corresponding compression instructions can be sent to the central control unit 31 through the user operating on the user operation interface 36. Referring to FIG. 2 again, upon obtaining the compression instructions sent by the central control unit 31, the image compression/decompression computing unit 35 obtains the DICOM image data to be compressed from the storage unit 34 and compresses the DICOM image data according to the above described steps. First, the image data of the area outside field of view and/or the image data of air is determined based on the specific CT value of the DICOM image data, for example, the CT value of the data of the area outside field of view is −3024 and/or the CT value of air is −1000, the compression computing unit deletes the image data to be deleted and unnecessary for clinical diagnosis that are found out by the determining unit, such as the data of the area outside field of view and/or the air data, and the corresponding record information is created and stored in the storage unit 34. Second, a CT value classification template the CT value of each of the pixels belongs to is determined based on the CT value classification templates and the CT value of the each of the pixels of the image within field of view in the DICOM image data, the pixel data is compressed based on the classification template to which the pixel data belongs to said classification template using the corresponding compression algorithm, for example, the respective pixel data are compressed using the previously mentioned formula (1). Finally, the compressed image data is obtained and stored in the storage unit 34.

Wherein, the CT value classification templates can be classified as four types A, B, C and D as described in step 12 of the compression method, or the user can create the CT value classification templates according to his own requirement and set a compression encoding method for each classification template as formula (1) in the above-described compression method, or other lossless or lossy compression encoding methods as described above.

In order to display an accurate and complete image, the compressed image needs to be decompressed. The central control unit 31 controls the image compression/decompression computing unit 35 to decompress the compressed image. The decompression computing unit 352 in the image compression/decompression computing unit 35 obtains the image data to be decompressed from the storage unit 34 under the control of the central control unit 31, and decompresses and decodes the image data using the decompression method corresponding to the compression and encoding according to the CT value classification templates to which the image data belong. For example, when the compression and encoding uses the compression and encoding method as described by formula (1), the decompression method as described by the corresponding formula (2) is used for performing decompression so as to recover the image data. Meanwhile, the decompression computing unit 352 recovers the deleted image data, such as the data of the area outside field of view and the air data, by adding the data of the area outside field of view as stored in the storage unit 34 to the decompressed image to recover the area outside field of view of the image.

The CT value classification templates along with the compression and encoding algorithm of each classification template and the corresponding decompression algorithm are pre-stored in the storage unit 34.

Referring to FIG. 6 again, the user can operate on the image through the user operation interface 36, and select the important part that is not to be compressed so as to protect it. Then the central control unit 31 controls the image compression/decompression unit 35 not to compress the protected image data.

In order to increase the compression ratio, the user can remove the image data, such as the data of the area outside field of view, that is useless to clinical diagnosis according to his own need. For example, a CT image includes a lot of air data. They are substantially useless to the clinical diagnosis except in the lung image, so said part of image data can be deleted. The CT apparatus can make a judgment according to the pre-set CT values of the substances and tissues. For example, the CT value of air is −1000, and if the user selects the operation key of “Delete Air Data” on the user operation interface 36, the compression computing unit in the image compression/decompression computing unit 35 deletes the air data in the DICOM image, and meanwhile creates a piece of corresponding record information in the storage unit 34. When decompression is performed to recover the image data, the air data can be recovered according to the corresponding record information.

1. A method for compressing a CT-reconstructed image, said method comprising:
obtaining a reconstructed image to be compressed, the reconstructed image including an area outside field of view and an area within field of view;
determining, according to a plurality of preset CT value classification templates, which type of CT value classification template a CT value of each of a plurality of pixels in the area within field of view in the reconstructed image belongs to; and
compressing pixel data that belong to the respective CT value classification templates according to the CT value classification templates and compression methods determined for the respective CT value classification templates.

2. The method for compressing a CT-reconstructed image according to claim 1, further comprising removing data in the area outside field of view and establishing corresponding record information.

3. The method for compressing a CT-reconstructed image according to claim 2, wherein the reconstructed image is an image in Digital Imaging and Communications in Medicine (DICOM) format, which is a matrix of 512×512.

4. The method for compressing a CT-reconstructed image according to claim 3, wherein the preset CT value classification templates include the four types of A, B, C, and D, and wherein image data in the CT value classification template B is compressed in a lossless manner, and image data in the CT value classification templates A, C, and D is compressed in a lossy manner.

5. The method for compressing a CT-reconstructed image according to claim 4, wherein the compression corresponding to the A, B, C and D types of CT value classification templates is performed according to the formula of
$$y = \frac{x - intercept}{slope} ,$$
wherein y is the result of compression, x is the CT value of the respective pixels, intercept is the lower limit value of each classification; template, and slope is the compression ratio of each classification template, which is constant and can be defined by a user according to his own requirement, the slope corresponding to the CT value classification template is 1.

6. The method for compressing a CT-reconstructed image according to claim 5, wherein the slopes corresponding to the CT value classification templates A, C, and D are 4, 2 and 9 respectively.

7. The method for compressing a CT-reconstructed image according claim 4, wherein the A, B, C and D types of CT value classification templates are represented by binary numbers, such that A is represented by 00, B is represented by 01, C is represented by 10 and D is represented by 11.

8. The method for compressing a CT-reconstructed image according to claim 7, wherein the CT value of the pixels in the area outside field of view is −3024.

9. A method of decompressing a compressed CT-reconstructed image, said method comprising the following steps:
obtaining compressed image data to be decompressed;
decompressing the compressed image data using a corresponding decompression algorithm according to a CT value classification template where each of pixel data resides;
recovering image data in an area outside field of view;
adding the image data in the area outside field of view to the decompressed image to obtain a complete image.

10. The method of decompressing a compressed CT-reconstructed image according to claim 9, wherein the compressed image data are decompressed using the formula of x=y·slope+intercept, wherein x represents the decompressed image data, y represents the compressed image data, and the compression ratio slope and the intercept depend on the CT value classification templates where they reside.

11. A CT apparatus comprising:
a scanning table configured to perform X-ray scanning on a subject;
a data collection unit configured to collect scanning data output from the scanning table and to perform an analog-to-digital conversion thereon;
a user operation interface configured to enable user operation;
a storage unit configured to store data and information; and
an image reconstruction unit configured to reconstruct an image according to the scanning data sent from the data collection unit, to store the reconstructed image data in the storage unit, and to display the reconstructed image data on the user operation interface;
a central control unit connected to an output terminal of the image reconstruction unit and configured to control the scanning table, the data collection unit, the user operation interface and the storage unit, wherein:
the storage unit is configured to store CT value classification templates and compression and decompression algorithms applied to the CT value classification templates;
the CT apparatus further comprises an image compression/decompression computing configured to call the CT value classification templates and the corresponding compression and decompression algorithms stored in the storage unit to one of compress the reconstructed image and decompress the compressed image.

12. The CT apparatus according to claim 11, wherein the image compression/decompression computing unit comprises a compression computing unit and a decompression computing unit, the central control unit configured to automatically control the compression computing unit to compress the image reconstructed by the image reconstruction unit based on a compression instruction sent to the central control unit by the user operating on the user operation interface.

13. The CT apparatus according to claim 12, the image reconstructed by the reconstruction unit is an image in Digital Imaging and Communications in Medicine (DICOM) format, which is a matrix of 512×512 and includes an area within field of view and an area outside field of view.

14. The CT apparatus according to claim 13, wherein the CT value classification templates include four types of A, B, C, and D, and wherein image data in the CT value classification template B is compressed in a lossless manner, and image data in the CT value classification are templates A, C, and D is compressed in a lossy manner.

15. The CT apparatus according to claim 14, wherein:
the compression corresponding to said A, B, C and D types of CT value classification templates is performed according to the formula of
$$y = \frac{x - intercept}{slope} ,$$
wherein y is the result of compression, x is the CT value of the respective pixels, intercept is the lower limit value of each classification template, and slope is the compression ratio of each classification template, which is a constant and can be defined by the user according to his own requirement, the slope corresponding to the CT value classification template B is 1; and
the corresponding method of decompressing the compressed image data is x=y·slope+intercept, wherein x represents the decompressed image data, y represents the compressed image data, the compression ratio slope and the intercept depend on the respective CT value classification templates where they reside.

16. The CT apparatus according to claim 15, wherein the slopes corresponding to the CT value classification templates A, C, and D are 4, 2 and 9 respectively.

17. The CT apparatus according to claim 14, wherein the A, B, C and D types of CT value classification templates are represented by binary numbers, such that A is represented by 00, B is represented by 01, C is represented by 10 and D is represented by 11.

18. The CT apparatus according to claim 13, wherein the compression computing unit is configured to:
receive the instruction of compressing the reconstructed image sent from the central control unit;
call the reconstructed image data to be compressed from the storage unit and delete the data in the area outside field of view in the image
determine which CT value classification template the CT value of each of the pixels in the area within field of view in the image belongs to; and
compress the pixel data according to the compression algorithm of the CT value classification templates to which the respective pixels belongs, wherein an operation key of “Delete Air Data” is provided on the user operation interface.

19. The CT apparatus according to claim 18, the decompression computing unit is configured to:
receive the instruction of decompressing the compressed reconstructed image sent from the central control unit;
call the image data to be decompressed from the storage unit and decompress the compressed pixel data according to the decompression algorithm of the CT value classification templates to which the respective pixels belong;
recover the image data in the area outside field of view; and
add the data in the area outside field of view to the decompressed image to obtain a complete image.

20. The CT apparatus according to claim 19, the compression computing unit is configured to delete data in the area outside field of view by creating and storing a piece of corresponding record information in the storage unit at the same time such that the image data compressed by the compression computing unit and the image data decompressed by the decompression computing unit are stored in the storage unit.
